(19) United States
(12) Patent Application Publication
(10) Pub. No.: US 2007/0071607 A1
(43) Pub. Date: Mar. 29, 2007

(54) High-temperature-resistant component

(76) Inventor: Winfried Esser, Bochum (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/580,696

(22) PCT Filed: Oct. 21, 2004
(86) PCT No.: PCT/EP04/11923

§ 371 Date: May 25, 2006

(30) Foreign Application Priority Data
Nov. 27, 2003 (EP) 03027388.2

(51) Int. Cl. F03B 3/12

(52) U.S. Cl. 416/241 R

(57) ABSTRACT

The invention a high temperature resistant component made of an alloy, in particular a nickel-based-super alloy in the following composition and expressed in weight percentage: 9-13% Cr, 3-5% W, 0.5-2.5% Mo, 3-5% Ti, 3-7% Ta, 1-5% Re, up to 2000 ppm of a solidification promoter, the remainder being nickel.

### CROSS REFERENCE TO RELATED APPLICATIONS

This application is the US National Stage of International Application No. PCT/EP2004/011923, filed Oct. 21, 2004 and claims the benefit thereof. The International Application claims the benefits of European Patent application No. 03027388.2 filed Nov. 27, 2003. All of the applications are incorporated by reference herein in their entirety.

### FIELD OF THE INVENTION

The invention relates to a high-temperature-resistant component made from an alloy, in particular from a nickel-base, cobalt-base or iron-base superalloy, with precipitations.

### BACKGROUND OF THE INVENTION

DE 23 33 775 B2 describes a process for the heat treatment of a nickel alloy. The nickel alloy consists of up to 0.3% carbon, 11-15% chromium, 8-12% cobalt, 1-2.5% molybdenum, 3-10% tungsten, 3.5-10% tantalum, 3.5-4.5% titanium, 3-4% aluminum, 0.005-0.025% boron, 0.05-0.4% zirconium, remainder nickel. Furthermore, 0.01-3% hafnium are additionally present in the alloy. The heat treatment described produces a block-like carbide formation and a finely dispersed precipitation of an Ni₃ (Al, Ti) phase.

U.S. Pat. No. 5,611,670 discloses a rotor blade for a gas turbine. The rotor blade has a single-crystal platform region and a single-crystal main blade part. A securing region of the blade is designed with a directionally solidified structure. The blade is cast from a superalloy which has the following composition, in percent by weight: up to 0.2% carbon, 5-14% chromium, 4-7% aluminum, 2-15% tungsten, 0.5-5% titanium, up to 3% niobium, up to 6% molybdenum, up to 12% tantalum, up to 10.5% cobalt, up to 2% hafnium, up to 4% rhenium, up to 0.035% boron, up to 0.035% zirconium, remainder nickel. These wide range stipulations serve to indicate alloy compositions which are fundamentally suitable for the proposed gas turbine blade but do not reveal a composition range which is suitable for achieving a particular strength or resistance to oxidation and corrosion.

EP 0 297 785 B1 has disclosed a nickel-base superalloy for single crystals. The superalloy has the following composition, in percent by weight: 6-15% chromium, 5-12% tungsten, 0.014% rhenium, 3-9% tantalum, 0.5-2% titanium, 4-7% aluminum and optionally 0.5-3% molybdenum. This superalloy achieves both a resistance to high-temperature cracking and a resistance to corrosion. In order not to adversely affect the resistance to corrosion, the titanium content must not exceed two percent by weight.

U.S. Pat. No. 5,122,206 has described a nickel-base superalloy which has a particularly narrow coexistence zone for the solid and liquid phases and is therefore particularly suitable for a single-crystal casting process. The alloy has the following composition, in percent by weight: 10-30% chromium, 0.1-5% niobium, 0.1-8% titanium, 0.1-8% aluminum, 0.05-0.5% copper or 0.1-3% tantalum instead of copper; in the former case, hafnium or rhenium may optionally also be present in an amount of 0.05-3%, and in the latter case 0.05-0.5% copper may also be present instead of rhenium or hafnium. Furthermore, 0.05-3% molybdenum or tungsten may optionally also be provided.

WO 01/09403 A1 discloses a nickel-base alloy containing 11-13% chromium, 3-5% tungsten, 0.5-2.5% molybdenum, 3-5% aluminum, 3-5% titanium, 3-7% tantalum, 0-12% cobalt, 0-1% niobium, 0-2% hafnium, 0-1% zirconium, 0-0.05% boron, 0-0.2% carbon, 1-5% rhenium, 0-5% ruthenium, remainder nickel. The formation of embrittling intermetallic phases (Cr- and/or rhenium-containing precipitations) which is promoted by rhenium leads to a reduction in the service life on account of the formation of cracks.

U.S. Pat. No. 3,907,555 discloses an alloy which contains up to 6.5% tin. The tin levels are at least 1.0 wt %.

U.S. Pat. No. 4,708,848 lists tin as a constituent of an Ni-base alloy, in which the permissible level of tin must be lower than 25 ppm. This means that the tin fraction represents an undesirable impurity.

U.S. Pat. No. 6,308,767 discloses a method for producing directional structures from a superalloy, in which a melt is cooled in another liquid metal. However, it is necessary to ensure that tin does not contaminate the superalloy. Tin is therefore an undesirable constituent of the alloy.

U.S. Pat. No. 6,505,673 has disclosed a soldering alloy which contains 4.5% tin.

### SUMMARY OF THE INVENTION

Precipitations, for example the γ′ precipitations in the case of superalloys, which are established by suitable heat treatments in the superalloy after casting, are crucial to the service life and mechanical properties, in particular at high temperatures.

The invention is based on the object of providing a component made from an alloy, in particular from a nickel-base, cobalt-base or iron-base superalloy, which has particularly favorable properties with regard to high-temperature resistance, resistance to oxidation and corrosion and stability with respect to ductility-reducing formation of intermetallic phases over a long service life.

According to the invention, the object relating to a component is achieved by the provision of a high-temperature-resistant component made from an alloy which contains at least one strength promoter in an amount of at most 2000 ppm, in particular 1100 ppm.

The addition of tin has proven to have good results in this context.

The strength can be improved by a refined and high level of precipitations (γ′ phase) in the alloy.

The strength promoter has particularly advantageous effects in a nickel-base, cobalt-base or iron-base superalloy, the composition of which comprises the following elements, in percent by weight (wt %):

9-<11% chromium (9 to less than 11),

3-5% tungsten,

0.5-2.5% molybdenum,

3-5%, in particular 3-<3.5% aluminum (3 to less than 3.5%),

3-5% titanium,

3-7% tantalum,

0.1-10% rhenium and/or ruthenium, in particular up to 5%,

at most 2000 ppm strength promoter,

remainder nickel, cobalt or iron and impurities.

The strength promoter also has advantageous effects in a nickel-base, cobalt-base or iron-base superalloy, the composition of which comprises the following elements, in percent by weight (wt %):

11-13% chromium,

3-5% tungsten,

0.5-2.5% molybdenum,

3-5% aluminum,

3-5% titanium,

3-7% tantalum,

0.1-10% rhenium and/or ruthenium, in particular up to 5%,

at most 2000 ppm strength promoter,

remainder nickel, cobalt or iron and impurities.

Particularly good results were found for a nickel-base superalloy. For the first time, the composition of the superalloy of the component described has been made so specific that the component has particularly favorable properties with regard to its ability to withstand high temperatures, its resistance to oxidation and corrosion and with regard to its stability with respect to the formation of ductility-reducing intermetallic phases.

Extensive tests which preceded the invention made it possible to determine specific strength promoters which satisfy the desired properties mentioned above to a surprisingly high degree. In particular, the invention is in this context based on a chromium-rich superalloy.

A refined and high level of precipitations is achieved by the addition of the strength promoter, for example as a result of the latter constituting a defect in the system and serving as a nucleator or nucleation initiator, so that even small quantities are sufficient.

A large number of in particular refined precipitations are formed.

The minimum precipitation promoter content is preferably at least 50 ppm, in particular 75 ppm. It is preferably between 100 and 500 ppm and in particular 100 ppm.

It is preferable for the superalloy to contain at most one percent by weight of niobium.

It is preferable for the superalloy to optionally contain at least one of the following elements:

0-2% by weight hafnium,

0-1% by weight zirconium,

0-0.05% by weight boron,

0-0.2% by weight carbon.

A particularly good high-temperature resistance can advantageously also be achieved by adding ruthenium and without a rhenium content, in which case, with the composition indicated, the resistance to oxidation/corrosion is at the same time also high.

It is preferable for the cobalt content of the superalloy to be less than 12 percent by weight, while the niobium content is at most one percent by weight.

A cobalt content of between 6 and 10% and a zirconium content of between 0 and 0.1% are particularly advantageous.

It is preferable for the component to have a directionally solidified grain structure. In a directionally solidified structure, the grain boundaries are oriented substantially along one axis. This results in a particularly high strength along this axis.

It is preferable for the component to have a single-crystal structure. The single-crystal structure avoids strength-reducing grain boundaries in the component and results in a particularly high strength.

It is preferable for the component to be designed as a gas turbine guide vane or rotor blade. In particular a gas turbine blade or vane is subject to particularly high demand with regard to its ability to withstand high temperatures and to resist oxidation/corrosion.

The component may also be a part (blade or vane) of a steam turbine or aircraft turbine.

### BRIEF DESCRIPTION OF THE DRAWINGS

In the drawings:

FIG. 1 shows a blade or vane,

FIG. 2 shows a gas turbine,

FIG. 3 shows a combustion chamber,

FIGS. 4 to 7 show strength values.

The invention is explained in more detail below.

### DETAILED DESCRIPTION OF THE INVENTION

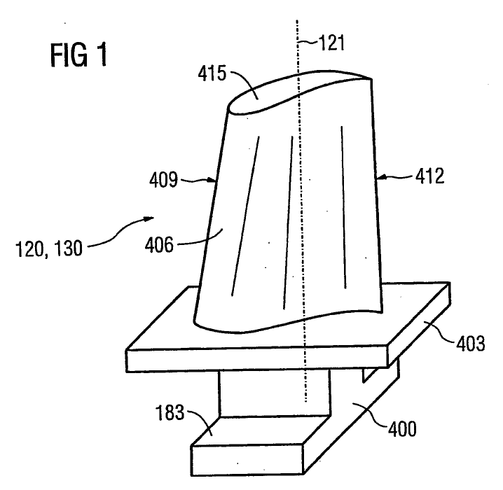

FIG. 1 shows a perspective view of a blade or vane 120, 130 which extends along a longitudinal axis 121.

The blade or vane 120 may be a rotor blade 120 or guide vane 130 of a turbo machine. The turbo machine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406. As a guide vane 130, the vane may have a further platform (not shown) at its vane tip 415.

A blade or vane root 183, which is used to secure the rotor blades 120, 130 to a shaft or disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example, solid metallic materials are used in all regions 400, 403, 406 of the blade or vane 120, 130.

The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blade or vane 120, 130 may be hollow or solid in form.

If the blade or vane 120, 130 is to be cooled, it is hollow and may also have film-cooling holes (not shown). To protect against corrosion, the blade or vane 120, 130 has, for example, suitable, generally metallic coatings, and to protect against heat it generally also has a ceramic coating.

The turbine blade or vane 120, 130 is made from a nickel-base, cobalt-base or iron-base superalloy which has, for example, one of the following compositions:

Cr: 10.25%, Mo: 1.85%, W: 4.70, Co: 6.50%, Ti: 3.75%, Ta: 3.9%, Al: 3.3%, B: 0.0125%, Zr: 0.008%, Hf: <0.01%, Re: 1.5%, remainder Ni, 1000 ppm Sn.

Cr: 9.00%, Mo: 1.85%, W: 4.70, Co: 6.50%, Ti: 3.75%, Ta: 3.9%, Al: 3.3%, B: 0.0125%, Zr: 0.008%, Hf: <0.01%, Re: 3.5%, remainder Ni, 1900 ppm Sn.

Cr: 12.75%, Mo: 1.85%: W: 4.70, Co: 6.50%, Ti: 3.75%, Ta: 3.9%, Al: 3.3%, B: 0.0125%, Zr: 0.008%, Hf: <0.01%, Re: 1.5%, Ru: 2.0% remainder Ni, 500 ppm Sn.

Cr: 10.25%, Mo: 1.85%, W: 4.70, Co: 8.50%, Ti: 3.75%, Ta: 3.9%, Al: 3.3%, B: 0.0125%, Zr: 0.008%, Hf: <0.01%, Ru: 1.5%, remainder Ni, 900 ppm Zn.

Cr: 11.75%, Mo: 1.85%, W: 4.70, Co: 8.50%, Ti: 3.75%, Ta: 3.9%, Al: 3.3%, B: 0.0125%, Zr: 0.008%, Hf: <0.01%, Ru: 3.75%, remainder Ni, 500 ppm Sn, 500 ppm Zn.

Cr: 10.25%, Mo: 1.85%, W: 4.70, Co: 8.50%, Ti: 3.75%, Ta: 3.9%, Al: 3.3%, B: 0.0125%, Zr: 0.008%, Hf: <0.01%, Re: 2.00%, Ru: 2.5, remainder Ni, 200 ppm Sn.

Cr: 9.25%, Mo: 1.85%, W: 4.70, Co: 6.50%, Ti: 3.75%, Ta: 3.9%, Al: 3.0%, B: 0.0125%, Zr: 0.008%, Hf: <0.01%, Re: 3.5%, remainder Ni, 100 ppm Sn.

Examples of further strength promoters include lead (Pb), gallium (Ga), calcium (Ca), selenium (Se), arsenic (As); bismuth (Bi), neodymium (Nd), praseodymium (Pr), copper (Cu), aluminum oxide (Al₂O₃), magnesia (MgO), hafnia (HfO₂), zirconia (ZrO₂), spinels (MgAl₂O₄), carbides or nitrides or also iron (Fe) in nickel-base or cobalt-base superalloys.

It is also possible to use a plurality of strength promoters. The strength promoters may be metallic and/or ceramic. It is possible to use various strength promoters comprising metal and/or ceramic.

The quantity added in ppm always relates to the total quantity of precipitation promoters.

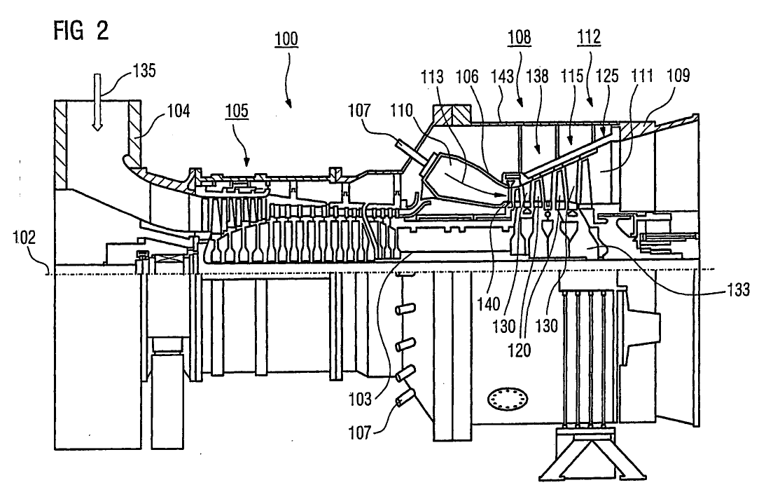

FIG. 2 shows, by way of example, a partial longitudinal section through a gas turbine 100.

In the interior, the gas turbine 100 has a rotor 103 which is mounted such that it can rotate about an axis of rotation 102 and is also referred to as the turbine rotor.

An intake housing 104, a compressor 105, a, for example, toroidal combustion chamber 110, in particular an annular combustion chamber 106, with a plurality of coaxially arranged burners 107, a turbine 108 and the exhaust-gas housing 109 follow one another along the rotor 103.

The annular combustion chamber 106 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133. A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113.

From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield bricks which line the annular combustion chamber 106, are subject to the highest thermal stresses.

To be able to withstand the temperatures which prevail there, they have to be cooled by means of a coolant.

The substrates may likewise have a directional structure, i.e. they are in single-crystal form (SX structure) or have only longitudinally oriented grains (DS structure).

The materials used are iron-base, nickel-base or cobalt-base superalloys of the alloy according to the invention.

The blades or vanes 120, 130 may also have coatings which protect against corrosion (MCrAIX; M is at least one element selected from the group consisting of iron (Fe), cobalt (Co), nickel (Ni), X stands for yttrium (Y) and/or at least one rare earth element) and heat by means of a thermal barrier coating. The thermal barrier coating consists, for example, of ZrO₂, Y₂O₄—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

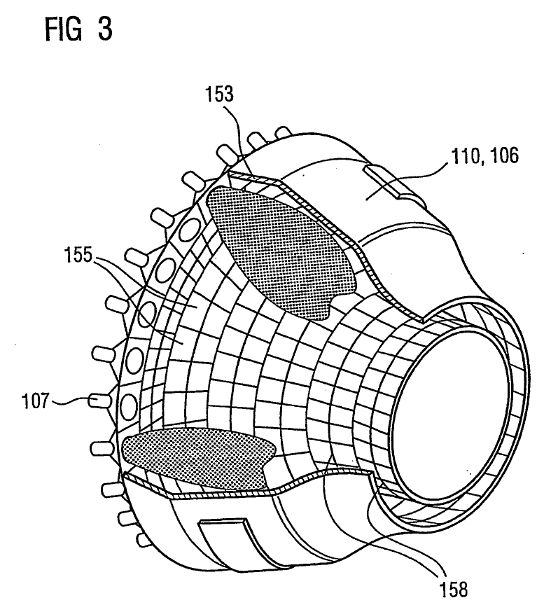

FIG. 3 shows a combustion chamber 110 of a gas turbine. The combustion chamber 110 is configured, for example, as what is known as an annular combustion chamber, in which a multiplicity of burners 102 arranged circumferentially around the turbine shaft 103 open out into a common combustion chamber space. For this purpose, the combustion chamber 110 overall is configured as an annular structure which is positioned around the turbine shaft 103.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155. On the working medium side, each heat shield element 155 is equipped with a particularly heat-resistant protective layer or is made from a material that is able to withstand high temperatures. Moreover, on account of the high temperatures in the interior of the combustion chamber 110, a cooling system is provided for the heat shield elements 155 and/or for their holding elements.

The materials used for the combustion chamber wall 153 and their coatings are similar to those used for the turbine blades or vanes 120, 130.

The combustion chamber 110 is designed in particular to detect losses of the heat shield elements 155. For this purpose, a number of temperature sensors 158 are positioned between the combustion chamber wall 153 and the heat shield elements 155.

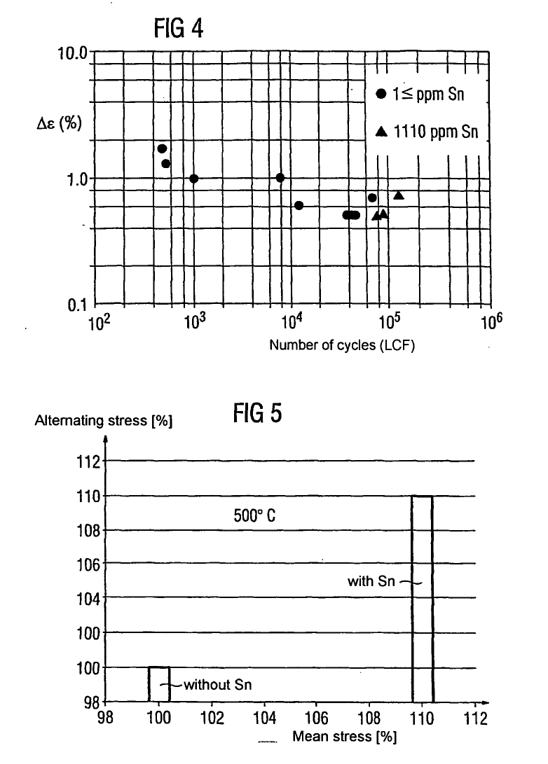

FIG. 4 shows the results of a low cycle fatigue (LCF) test.

In a low cycle fatigue test, a defined relative elongation Δε is predetermined, i.e. the specimen is alternately subjected to tensile or compressive loads with a predetermined relative elongation.

The elongation is predetermined and the test is carried out at different temperatures, such as for example 850° C. or 950° C. The number of cycles N is measured. The maximum number of cycles carried out before the specimen fractures is plotted in the diagram.

Therefore, in the diagram the better specimens are the ones which have the greater number of cycles at a defined elongation Δε. The tests were carried out using a specimen made from an alloy PWA 1483 with a minimal tin content <1 ppm and a tin content of 1110 ppm.

The curves with the 1110 ppm tin content have higher cycle numbers N than the specimens without tin (≦1 ppm).

FIG. 5 shows the test results for high cycle fatigue tests at 500° C.

In this case, various alternating stresses are applied at a defined temperature and a predetermined mean stress and a predetermined number of cycles in order to achieve a desired cycle number of 10⁸ cycles (fatigue strength).

The mean stress value for the specimen without tin is illustrated here standardized to 100%.

The value for the alternating stress achieved for the specimen without tin is likewise illustrated standardized to 100%.

It was possible for the specimens with tin (100 ppm) to be exposed to higher alternating stresses even with a higher mean stress in order to achieve the desired cycle number of 10⁸ cycles (fatigue strength).

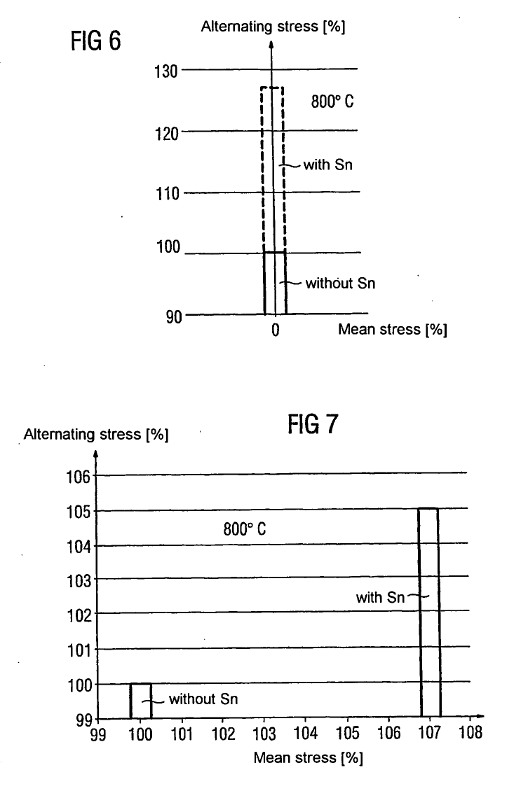

FIG. 6, like FIG. 5, shows the test results at a higher temperature of 800° C. with a mean stress of 0 MPa.

The value for the alternating stress achieved for the specimen without tin is illustrated standardized to 100%.

In this case too, the specimens containing 100 ppm of tin are superior to the specimens without tin.

FIG. 7, like FIG. 6, shows the test results at the temperature of 800° C. under a mean stress which is standardized to the mean stress of the specimen without tin.

The value for the alternating stress achieved for the specimen without tin is likewise illustrated standardized to 100%.

It was possible for the specimens containing tin (100 ppm) to be exposed to a higher alternating stress even with a higher mean stress in order to achieve the desired number of cycles of 10⁸ cycles (fatigue strength).

1-18. (canceled)

19. A high temperature gas turbine component comprising:
a root section;
a platform section arranged adjacent to the root section;
a tip section arranged radially opposite the root section;
a leading edge arranged between the platform and tip sections;
a trailing edge arranged downstream of the leading edge; and
a main section arranged between the leading edge, trailing edge, platform section and tip sections,
wherein, the superalloy is precipitation strengthened by the addition of 50 ppm to 2000 ppm of a strength promoter selected from the group consisting of:
zinc (Zn),
tin (Sn),
lead (Pb),
gallium (Ga),
calcium (Ca),
selenium (Se),
arsenic (As),
bismuth (Bi),
neodymium (Nd), and
praseodymium (Pr).

20. The component as claimed in claim 19, wherein the high temperature gas turbine component is a turbine blade or vane.

21. The component as claimed in claim 20, wherein the alloy, further comprises (percent by weight):
11-13% chromium,
3-5% tungsten,
0.5-2.5% molybdenum,
3-5% aluminum,
3-5% titanium,
3-7% tantalum,
0-12% cobalt,
0-1% niobium,
0-2% hafnium,
0-1% zirconium,
0-0.05% boron,
0-0.2% carbon,
0.1-10% rhenium or ruthenium, and
remainder nickel, cobalt or iron and impurities.

22. The component as claimed in claim 20, wherein the alloy further comprises (percent by weight):
9-<11% chromium,
3-5% tungsten,
0.5-2.5% molybdenum,
3-5% aluminum,
3-5% titanium,
3-7% tantalum,
0-12% cobalt,
0-1% niobium,
0-2% hafnium,
0-1% zirconium,
0-0.05% boron,
0-0.2% carbon,
0.1-5% ruthenium, or rhenium, and
remainder nickel, cobalt or iron and impurities.

23. A gas turbine high temperature resistant component made from a precipitant containing alloy, comprising:
a metallic strength promoter in an amount of 50 ppm to 2000 ppm that increases the strength of the component by increasing the formation of precipitants where the strength promoter is selected from the group consisting of:
zinc (Zn),
tin (Sn),
lead (Pb),
gallium (Ga),
calcium (Ca),
selenium (Se),
arsenic (As),
bismuth (Bi),
neodymium (Nd), and
praseodymium (Pr).

24. The component as claimed in claim 23, wherein the component consists of a nickel-base, cobalt-base or iron-base superalloy.

25. The component as claimed in claim 23, wherein the alloy contains up to 1100 ppm of the strength promoter.

26. The component as claimed in claim 25, wherein the alloy contains between 100 to 500 ppm of the strength promoter.

27. The component as claimed in claim 24, wherein the alloy, further comprises (percent by weight):
11-13% chromium,
3-5% tungsten,
0.5-2.5% molybdenum,
3-5% aluminum,
3-5% titanium,
3-7% tantalum,
0-12% cobalt,
0-1% niobium,
0-2% hafnium,
0-1% zirconium,
0-0.05% boron,
0-0.2% carbon,
0.1-10% rhenium or ruthenium, and
remainder nickel, cobalt or iron and impurities.

28. The component as claimed in claim 24, wherein the alloy further comprises (percent by weight):
9-<11% chromium,
3-5% tungsten,
0.5-2.5% molybdenum,
3-5% aluminum,
3-5% titanium,
3-7% tantalum,
0-12% cobalt,
0-1% niobium,
0-2% hafnium,
0-1% zirconium,
0-0.05% boron,
0-0.2% carbon,
0.1-5% ruthenium, or rhenium, and
remainder nickel, cobalt or iron and impurities.

29. The component as claimed in claim 28, wherein the alloy contains 3—less than 3.5 aluminum percent by weight.

30. The component as claimed in claim 27, wherein the rhenium content is 1.3-10 percent by weight.

31. The component as claimed in claim 27, wherein the rhenium content is 1.3-5 percent by weight.

32. The component as claimed in claim 31, wherein the ruthenium content is 1.3-3 percent by weight.

33. The component as claimed in claim 28 wherein the ruthenium content is 0.5-5 percent by weight.

34. The component as claimed in claim 33, wherein the component material has an isotropic distribution, directionally solidified, or single-crystal grain structure.

35. The component as claimed in claim 33, wherein the component is a gas turbine blade, vane or combustion chamber component.

36. The component as claimed in claim 24, wherein the precipitation is the γ′ phase.

37. The component as claimed in claim 23, wherein the strength promoter is present in an amount of 75 ppm to 2000 ppm.

38. A gas turbine engine, comprising:
a rotationally mounted rotor arranged coaxially with the longitudinal axis of the engine;
an intake housing arranged coaxially with the rotor that intakes a working fluid;
a compressor that compresses the working fluid;
an annular combustion chamber comprised of a plurality of components that accepts the compressed working fluid, mixes a fuel with the compressed working fluid and combusts the compressed working fluid and fuel mixture to create a hot working fluid; and
a turbine section that expands the hot working fluid, wherein at least one combustion chamber or turbine component is formed from a nickel, cobalt or iron superalloy that is precipitation strengthened by the addition of 50 ppm to 2000 ppm of a strength promoter from the group consisting of:
zinc (Zn),
tin (Sn),
lead (Pb),
gallium (Ga),
calcium (Ca),
selenium (Se),
arsenic (As),
bismuth (Bi),
neodymium (Nd), and
praseodymium (Pr).
